(19) United States
(12) Patent Application Publication
(10) Pub. No.: US 2007/0136523 A1
(43) Pub. Date: Jun. 14, 2007

(54) Advanced dynamic disk memory module special operations

(76) Inventors: Randy M. Bonella, Portland, OR (US); Chung W. Lam, Hillsborough, CA (US)

Correspondence Address: RAYMOND J. WERNER, 2056 NW ALOCLEK DRIVE, SUITE 314, HILLSBORO, OR, 97124, US

(21) Appl. No.: 11/635,926

(22) Filed: Dec. 8, 2006

Related U.S. Application Data
(60) Provisional application No. 60/749,267, filed on Dec. 8, 2005.

(51) Int. Cl. G06F 13/00

(52) U.S. Cl. 711/113

(57) ABSTRACT

A memory module including a volatile memory, a non-volatile memory, and a controller that provides address, data, and control interfaces to the memories and to a host system, such as, for example, a personal computer, is operable to interact with the host system so as to provide one or more additional layers in the memory hierarchy of the host system. In one aspect of the present invention the controller operates the volatile memory of the memory module as a cache for the non-volatile memory of the memory module. In another aspect of the present invention data representing one or more software applications and/or one or more data sets are stored in the non-volatile memory of the memory module along with security information such that a host system may quickly launch applications from the memory module rather than from a slower hard disk drive.

### CROSS-REFERENCE TO RELATED APPLICATIONS

This non-provisional application claims the benefit of earlier filed provisional application No. 60/749,267, entitled “Advanced Dynamic Disk Memory Module”, filed 08 Dec. 2005; the entirety of which is hereby incorporated by reference.

### FIELD OF THE INVENTION

The present invention relates generally to a plug-and-play end-user add-in memory module for computers and consumer electronic devices, and more particularly relates to methods and apparatus for automatically managing active data sets in the memory module without external commands other than data set markers and for actively managing memory module maintenance operations independent of system control and in such a manner as to limit conflicts with normal memory module operations.

### BACKGROUND

Advances in semiconductor manufacturing technology and digital systems architecture have provided the basis for the design, manufacture, and large-scale distribution of a wide variety of sophisticated consumer electronic devices and products. Many of these electronic products provide at least one connection, or interface, for use with one or more removable memory storage units, also referred to as removable memory modules.

Removable memory modules have been used with personal computers (PC) for many years. Such removable memory modules, or storage media, are used for many applications. Historically, the primary use of removable memory modules has been for general data storage. More recently the use of removable memory modules for entertainment or consumer applications including but not limited to audio, video and still pictures has become common. Conventionally, the type of storage device, or memory, used in such memory modules has been FLASH memory or hard disk drive mechanical storage media.

What is needed are methods and apparatus for providing portable data storage with performance characteristics between those of main memory and FLASH or hard disk drives, and which can be easily added and removed from a host system, and which can further be used to restore an image to main memory without resorting to loading data from a slower hard disk drive.

### SUMMARY OF THE INVENTION

Briefly, a memory module including a volatile memory, a non-volatile memory, and a controller that provides address, data, and control interfaces to the memories and to a host system, such as, for example, a personal computer, is operable to interact with the host system so as to provide one or more additional layers in the memory hierarchy of the host system.

In one aspect of the present invention the controller operates the volatile memory of the memory as a cache for the non-volatile memory of the memory module.

In another aspect of the present invention data representing one or more software applications and/or one or more data sets are stored in the non-volatile memory of the memory module along with security information such that a host system may quickly launch applications from the memory module rather than from a slower hard disk drive.

In a further aspect of the present invention, since the memory module is in a different and independent path from that of the primary storage device, while the host system is booting from the memory module it can begin and service other requests from the primary storage device concurrently with the restore sequence.

### BRIEF DESCRIPTION OF THE DRAWINGS

FIG. 1 is a high level system block diagram of an illustrative memory module in accordance with the present invention.

FIG. 2 is a high level block diagram of an illustrative memory module controller, in accordance with the present invention, showing major functional blocks thereof.

FIG. 3 relates to a memory performance hierarchy and is a diagram illustrating a four-tier memory hierarchy of a personal computer system incorporating a memory module in accordance with the present invention.

FIG. 4 relates to a system boot manager and is a state transition diagram illustrating, in a personal computer, transitions from various mechanical power states to the possible states when a memory module in accordance with the present invention is incorporated in the personal computer system.

FIG. 5 is a power state transition diagram showing the state transitions occurring in an illustrative memory module controller in accordance with the present invention.

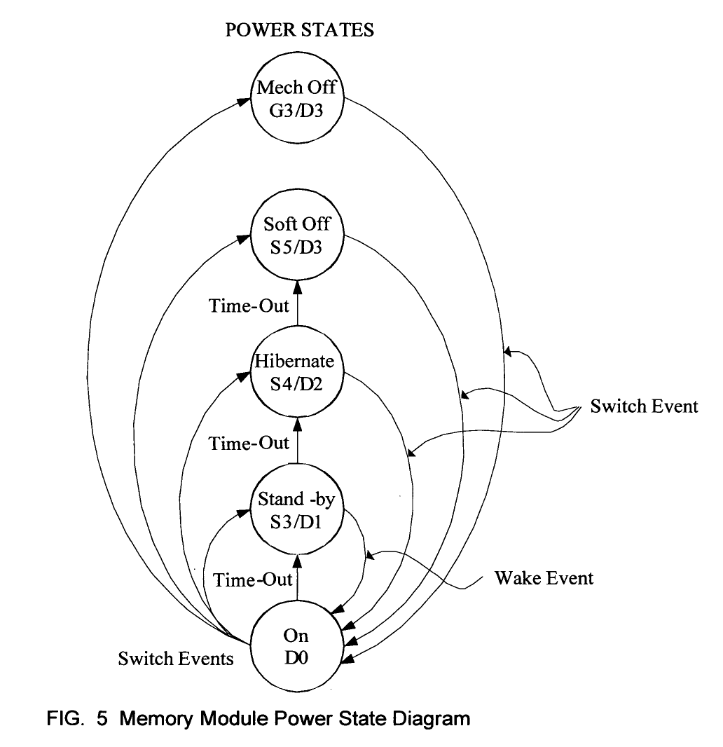

FIG. 6 is a state transition diagram of an illustrative Most Recently Used Information Manager suitable for use in a memory module controller in accordance with the present invention.

FIG. 7 is a state transition diagram of an illustrative Launch Acceleration Manager suitable for use in a memory module controller in accordance with the present invention.

FIG. 8 is a state transition diagram of an illustrative Launch Acceleration User Override Manager suitable for use in a memory module controller in accordance with the present invention.

FIG. 9 is a system block diagram of a conventional memory subsystem of a computer system.

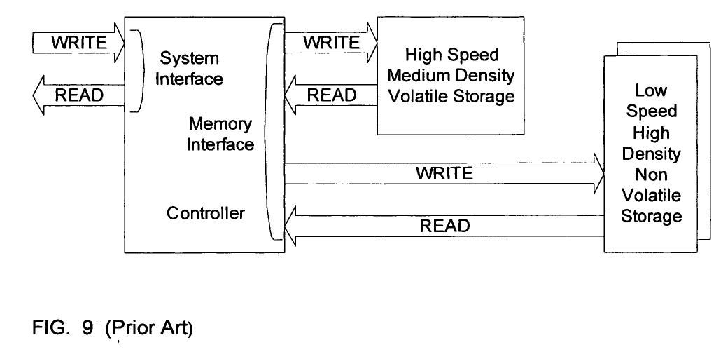

### DETAILED DESCRIPTION

Generally, a memory module with performance characteristics between those of main memory and non-volatile memory is provided on a separate path and allows, among other things, fast application launching, and concurrent servicing of multiple threads involving, for example, accessing the hard disk drive concurrently with application launching from the memory module. These and other functions and features of the memory module of the present invention are described in greater detail below.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Terminology

The terms integrated circuit (IC), semiconductor device, monolithic device, microelectronic device, and chip are often used interchangeably in the field of electronics. The present invention is applicable to all the above as they are generally understood in the field.

Memory modules in accordance with the present invention address the performance gap between main memory and mass storage (e.g., hard disk drives (HDD)). There is an ever growing performance gap between these two layers in the memory hierarchy.

It is noted that in a typical, but not required, application, a memory module in accordance with the present invention is an end-user add-in device. The portability aspect of such an embodiment is both a benefit and a problem. The benefits include, but are not limited to no added cost to the base system; flexible configurations to allow customization to specific needs; and independent system link such that it substantially reduces bus conflict when retrieving information in a highly threaded environment. Further benefits include, but are not limited to, a reduction of power, and an improved HDD reliability. The power savings and reliability are side benefits of being able to keep the HDD in the off state for extended periods of time. As for the problems due to the portable nature of the memory module, data encryption and security are useful to prevent the theft of data and/or the use of data that may have been modified without authorization.

Disclosed herein are several mechanisms to improve memory system performance while maintaining data integrity and security. As noted above, various embodiments of the present invention may incorporate one or more of these mechanisms. Power State Aware (PSA) is a mechanism where the memory module controller can act, to a predetermined extent, independently of the ACPI power state manager to reduce power consumption for the purpose of meeting desired performance or power criteria. Stored Image Integrity (SII) is a mechanism by which stored images are protected from modification and/or theft, including loading valid data sets based, at least in part, on predetermined file criteria. System Boot Manager is a mechanism that directs the memory module controller to source application code and data from the memory module and from specific memory types and locations within the memory module. Most Recently Used (MRU) is a mechanism where the most recently used data and applications are maintained in a highly ready state to ensure that the system, of which the inventive memory module form a part, responds as quickly as possible. User Selectable Application Acceleration is a mechanism in which a user selects which applications and data sets are to be managed and maintained in the memory module. Adaptive Learning Method is a mechanism in which the memory module adapts to user operations over a period of time in order to maintain a high state of readiness. Memory Maintenance Routines are the mechanisms by which the memory module is managed. Various embodiments of the present invention support one or more memory maintenance technologies. DRAM refresh, FLASH write wearing, emergency power loss, cache flushing, and security management are examples of such memory maintenance technologies.

To meet the growing need for performance improvements new memory module configurations are necessary to meet that performance demand. These new memory modules will use a combination of storage types to gain dramatic improvements in operational performance and storage capacity. In order for the different storage media to operate together cleanly and to deliver the highest possible performance special embedded operational functions must be defined. These embedded functions will be required to operate independent of normal system operations and must be designed to limit interference during normal operation.

With these various storage media types available to the system, predetermined data sets and applications can be associated with different types of storage media to extract the best desired system behavior. Various functions are described herein to improve system performance based on the particular abilities afforded by a hybrid memory configuration of memory modules in accordance with the present invention.

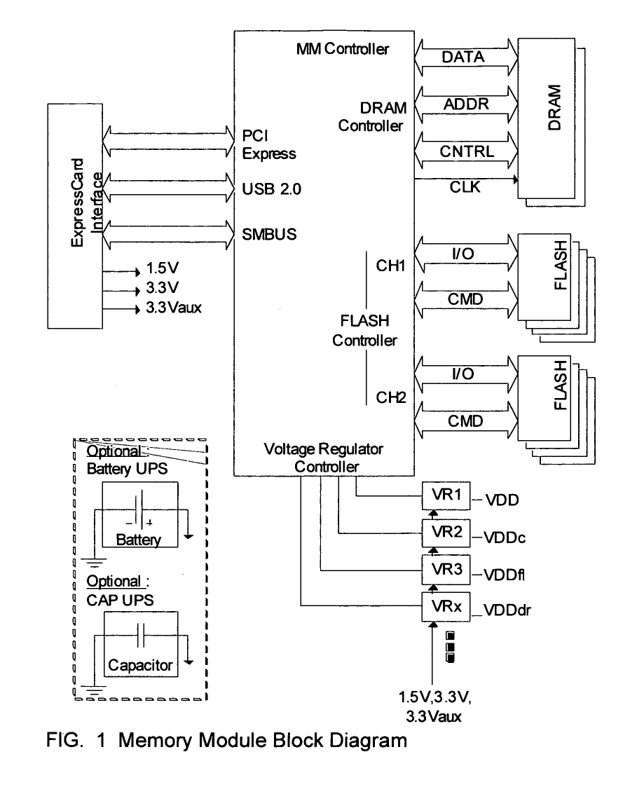

An illustrative memory module, in accordance with the present invention, uses a hybrid memory configuration wherein high speed volatile memory is used to improve memory module system performance and to manage temporary storage operations; and nonvolatile high density slower memory is used to store system data that is to be maintained regardless of power state. It is noted that non-volatile memories such as FLASH have write life limitations, and embodiments of the present invention allow the volatile memory of the memory module to be used at times in place of writes to the non-volatile memory, thereby effectively increasing the write life of the non-volatile memory. A simplified block diagram is shown in FIG. 1. The various types of storage media require maintenance operations to ensure proper long term operability.

Various embodiments of the present invention allow for the addition of system capabilities that have not previously been available in memory module technologies. In various embodiments, these capabilities operate substantially free from external control.

Memory Module

Referring to FIG. 1, an illustrative memory module is shown which consists of five major functional blocks and two lesser functional blocks. The major blocks are: an Express Card Interface; a memory module controller; a DRAM memory; a FLASH memory; and a voltage regulator (and/or one or more power transistors). The lesser blocks illustrated in FIG. 1 are: optional Uninterruptible Power Supply (UPS) capacitors or battery (for emergency shutdown operations); and various other electrical components such as decoupling capacitors, inductors, and so on, which are used for well-known miscellaneous functions in electronic products such as memory modules.

The memory module controller may be implemented as a single integrated circuit, or as a combination of two or more integrated circuits. The present invention is not limited to any particular partitioning, distribution, or grouping of functional blocks onto one or more integrated circuits. The Express Card Interface is considered the Host bus interface as defined by the ExpressCard 1.0 specification. All other elements of the interface, DRAM/FLASH types, can be customized for any supplier to any application or availability of parts. In alternative embodiments, other functional blocks can be added depending on applications or tasks that the memory module is intended to perform. The arrangement illustrated in FIG. 1 includes an embedded, or integrated, voltage regulator control block within the memory module controller. In some embodiments, the power electronics may also be integrated within the memory module controller. As noted above, the present invention is not limited to any particular partitioning, distribution, or grouping, of circuits or functional blocks.

The lesser blocks, mentioned above, make up the discrete components that are typically used for power decoupling, voltage regulator (VR) filtering, and fail safe DRAM data retention/emergency flushing, which various embodiments perform if power is lost prior to mirroring the DRAM data to a nonvolatile location.

In the illustrative embodiment of FIG. 1, all devices, with the exception of the memory module controller, are off-the-shelf components that are commercially available. It will be appreciated that the present invention is not limited to the use of any particular off-the-shelf commercially available components, and it will be further appreciated that the illustrated devices may be custom designed, and/or integrated in any suitable manner.

The battery UPS and CAP UPS are optional design features for the memory module controller. As part of the general architecture support for emergency power down conditions, backup power needs to be provided as an option. In some embodiments of the present invention, if power were lost and contents in the DRAM have not been saved in a non-volatile location then the intent would be to maintain a power reserve large enough to write the volatile data to a non-volatile location on the memory module. Such a non-volatile location on the memory module is typically implemented with FLASH memory, however the present invention is not limited to any particular non-volatile memory technology.

Memory Controller

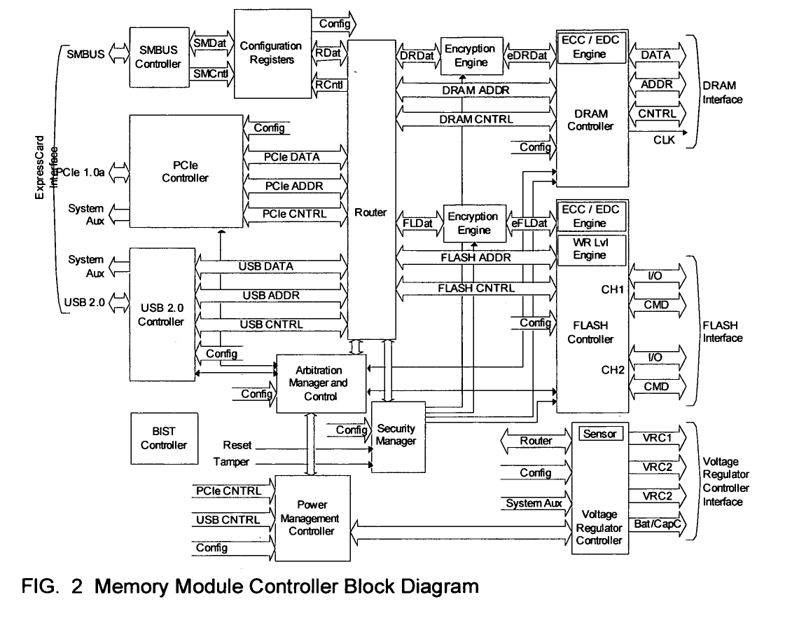

Referring to FIG. 2, an illustrative Memory Module Controller is shown that has six major blocks which interface to the external world. The ExpressCard Interface or Host includes a PCIe Controller; a USB Controller; and an SMBUS Controller. A DRAM Memory Controller; a FLASH Memory Controller; and a Voltage Regulator Controller make up the customizable back end of the illustrative memory module controller.

The PCIe (Host) interface in the illustrative embodiment of FIG. 2 conforms to the ExpressCard release 1.0 specification. In that specification, compatibility to the PCI Express 1.0a release and the USB 2.0 specification is called for. It is noted that it is not necessary for the memory module controller to have both interfaces. Supporting only one of the interfaces is sufficient to meet the ExpressCard release 1.0 specification.

The DRAM interface in the illustrative embodiment of FIG. 2 conforms to the IEEE DDR2 DRAM specification. It will be appreciated that the IEEE DDR2 DRAM specification can be replaced with a specification produced by a DRAM supplier, and that the circuitry of the DRAM controller can be modified so that the memory module controller is operable in accordance with the alternative DRAM specification.

The FLASH interface in the illustrative embodiment of FIG. 2 conforms to the IEEE NAND Flash Specification. It will be appreciated that the IEEE NAND Flash specification can be replaced with a specification produced by a FLASH supplier, and that the circuitry of the FLASH controller can be modified so that the memory module controller is operable in accordance with the alternative FLASH specification.

It is noted that the SMBUS controller must conform to the SMBUS 2.0 specification per the ExpressCard release 1.0 specification.

For reduced cost and simplicity of design, a Voltage Regulator controller is included in the illustrative memory module controller shown in FIG. 2. This is not a requirement of the ExpressCard release 1.0 specification. In some embodiments of the present invention, the integrated VR controller can be disabled, and an external VR can be incorporated into a memory module.

Still referring to FIG. 2, there are several internal blocks that define the functionality of the memory module controller. These basic core functions and resources are supported to maximize the system performance based on the memory module resources that are available. These internal blocks include a Data, Address and command router; a Router Arbitration and control module; a Security manager; a CPRM manager and encryption engine; an AES manager and encryption engine (one per Data Storage path); an ECC/EDC Engine (one per Data storage path); a Write Leveling engine for the FLASH controller; and a sensor circuit operable to produce at least one signal that is representative of a voltage variable performance parameter of a memory module controller integrated circuit.

Still referring to FIG. 2, the router is a functional block that acts as the bus traffic control center. Data, Address and Command paths from the PCIe bus and the USB 2.0 bus destinations are controlled by the router. Two of the functions supported by the router are: 1) DRAM as RD/WR Cache to the FLASH memory; and 2) operation of the DRAM fully independent from FLASH, with the FLASH maintenance functions built into the hardware of the memory module controller. The FLASH maintenance functions are built into the controller and do not require system or user intervention.

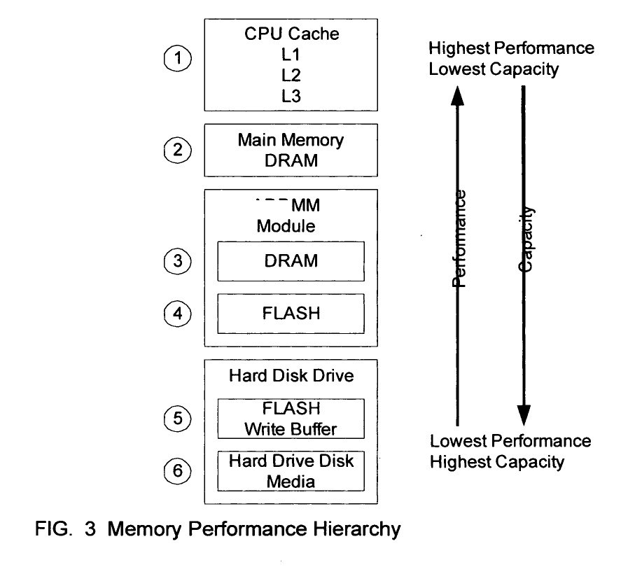

In various embodiments of the present invention, both router functions mentioned above are included since it may not be known if the operating system can easily or successfully delineate the difference between the two types of memory. If the DRAM is treated as a cache to the FLASH, then traditional cache management functionality is required. In some embodiments, software drivers are used to take advantage of the memory module with fully independent DRAM and FLASH operations. This effectively is having the memory module behave as though two more layers of memory hierarchy are disposed in the system between main memory and the HDD as shown in FIG. 3.

The Router block of the illustrative embodiment shown in FIG. 2 is made up of path multiplexers for Address, Command and Data. Address and Command paths are unidirectional from the host to the memory, whereas the data path is bi-directional, i.e., having both a path from the host to the memory and a path from memory back to the host. The term bi-directional as used here indicates that signals travel in two directions, rather than the more limiting sense of using a single wire to transfer information in both directions. The bidirectional nature of the Data path can be managed as a read path and a write path independent of each other. Such an independent arrangement allows for increased performance and flexibility.

The Router block functionality may be implemented by either a fixed hardwired state machine controller configurable via the config registers of the memory module controller; or by a microcontroller where the code to be executed by the microcontroller is stored in the FLASH memory of the memory module. This microcontroller implementation provides more flexibility for the operation of the module. It is noted that typical microcontroller architectures introduce the overhead of initial power-on latency and the possibility of slightly reduced performance.

The memory module controller in accordance with the present invention is “Power State Aware”. By having independent knowledge, separate from the ACPI control, of the power state and by having access to a user configuration of the power management window, the memory controller can use this information to improve performance under certain conditions and significantly reduce power consumption under other power managed conditions. The memory module controller follows the ACPI specification plus enhancements that are user configured and/or system configured.

In the D0 (On) and D1 (Standby) states there can be several power levels that can be configured depending on the importance of performance and/or battery life.

TABLE 1
Partial List of ACPI Power States

| ACPI | | Power | |
|---|---|---|---|
| Power | Power | Level | |
| State | Source | (0-5) | Memory Module operational Condition |
| D0 | Line/ | 5 | No operational restrictions, full power |
| | Battery | | |
| D0 | Battery | 4 | PCle/DRAM performance reduction, no |
| | | | FLASH restrictions |
| D0 | Battery | 3 | PCle/DRAM DRAM wr buffer only, FLASH |
| | | | restrictions |
| D1 | Line/ | 2 | DRAM in standby, FLASH idle |
| | Battery | | |
| D1 | Battery | 1 | DRAM in standby, FLASH standby |
| D1 | Battery | 0 | DRAM off, FLASH standby |

Power Level 5 level allows for full function, full performance operation. There are no preset restrictions placed on the DRAM, the FLASH, or any of the ExpressCard interfaces. The only restriction is what is gated by the thermal limit, or the power-in available limits for the ExpressCard devices as defined earlier, and there is no compromise on those limits.

Power Level 4 reduces power by limiting the DRAM performance and the PCIe transaction performance. This operating state is supported for battery operated devices. It is not required for battery mode operation and is considered user configurable.

Reduction of power in the DRAM can be accomplished in one of two ways: 1) reduce the maximum allowed number of read or write sequences in a given time period to the DRAM, essentially throttle the DRAM operation or reduce the frequency in which the DRAM is operating. A simple throttling algorithm can be used to restrict the number of cycles to the DRAM in any given time period. This reduces power and, in general, produces no noticeable decrease in system performance. The power saved by this type of throttling is good but not optimal.

An improved power saving option is to slow the operating frequency of the device down and restrict the number of requests being serviced by the ExpressCard interface. By doing this a significant savings in power can be achieved. Voltage can be reduced to the DRAM, frequency is reduced to the DRAM, and the number of cycle requests to the DRAM are reduced making the device function in a very lower power state while maintaining a reasonable system performance level. Power is calculated as the following: Power=Leakage+CV²f, so the ability to reduce voltage and frequency can result in major power savings. Some embodiments of the present invention include integrated voltage regulation circuitry for the memory module we have the capability of controlling this element on the module.

Power Level 3 provides a significant reduction in power, however performance of the memory module is reduced. In this power state the DRAM is used only as a write buffer to the FLASH memory. In this way, power consumed by the DRAM is reduced and power consumed by the interface is reduced as a consequence of the reduced number of access requests being processed. The DRAM is in an IDLE or STANDBY state most of the time and is only active when write traffic needs to be processed. This is substantially different than the operational states defined in Power Level 4 which allows both read and write traffic to be processed by the DRAM. As in the Power Level 4 Details, due to the lower operational state of the DRAM, voltage to the DRAM can be reduced as well as the frequency of operation by the DRAM thus saving additional power by the module.

Power Level 2 state is a standby state where low startup latency is wanted but without traffic being processed by the module. In this mode the DRAM is in a low power standby state and the FLASH is idle. Start-up latency by the DRAM is restricted by how deep a standby state is managed to the DRAM, clocks on or off, frequency of the clock and the voltage that is supplied to the DRAM. FLASH memory in IDLE allows for normal access to that memory without any latency hits.

In Power Level 1 there may be very little difference in the power consumed as compared to Power Level 2 since the amount of power consumed by the FLASH device in idle mode vs. standby mode is minor. An option to save power in this mode is to keep the DRAM in a low power standby state and to turn the power off to the FLASH device. Again the overall power savings may be small compared to Power Level 2.

In Power Level 0 the DRAM is turned off, and the FLASH may be turned off. Powering on the FLASH device adds to latency of operation but does reduce power.

Stored Image Integrity

Memory modules that contain non-volatile storage capability and uninterruptible power supply capability are used in many systems today for a wide variety of purposes. As noted previously in this disclosure, memory modules are typically removable devices. The stored image integrity methods and apparatus in accordance with the present invention are used to detect any change made to data previously stored on a memory module. Since the memory module is portable, i.e., removable, it is important to prevent inadvertent modifications and/or malicious tampering with the code and/or data stored thereon. For some applications and/or operating systems, it is important to know that the data being retrieved is what as originally stored. While a system is powered and operating this is not an issue as any storage device removed during operation most likely will not contain the latest image and therefore that image becomes useless to the system. The issue of image integrity occurs when a system is put into a power down state such as standby, hibernate or power-off. In any of these situations the memory module can be removed and returned without changes to the data image that is important to the system. In these cases, which would be quite prevalent, using existing systems' protocol the image would be required to be reloaded from the system's primary mass storage. This creates a situation where the system performance improvements are made non-functional. A mechanism in accordance with the present invention is provided to mark data sets and/or decrypt data sets. This mechanism provides the context by which the system can be put into any one of these power managed states, preserve the ability to remove the storage device, re-install the storage device and restart the system without having to re-load the stored contents, thus preserving the system response improvements.

Some Aspects of this Mechanism are:
1) The application and or data being stored is uniquely security encoded. This is not required but will limit and or eliminate the risk of data being stolen.
2) The application string can only be read back in a predefined order, i.e., no out of order reads, at a predefined starting address. This address start point and string length is stored in a controller register. In various embodiments, such a controller register is implemented as a volatile register in the controller, which is used in normal operation, and there is a table of this information maintained in non-volatile storage for when power is cycled off and on, and the information is to be restored.
3) The application string is bound to a machine or machines and can not be read unless it is in the specified machine(s). The binding is done through an encryption block. The encryption block uses the machine ID to decode the stored information.
4) Writing of the string can only be done as part of normal system operations. Insertion of latent strings is not allowed i.e., the application code is in effect write protected. This does not apply to data strings.
5) Data strings are read protected by items #1-3 if the device is in a different machine where in the case of element #1 the user does not know the password or key in the case of element #2 and #3 the device is in a different machine that was not the original host.

In an alternative embodiment multiple users are allowed on a single module and those multiple users may be bound to different machines and/or use secure passwords to move information from one machine to another.

There are several approaches for securing the stored information, which approaches involve operations by the system to which a memory module in accordance with the present invention may be coupled. In one approach, an Advanced Encryption Standard (AES) encryption block is used with an associated user-controlled password. In another approach, an AES encryption block is used with an associated password that is machine only generated and controlled. In yet another approach, a CRC checking block, in the system code, determines, when retrieving the data from the storage device, whether the retrieved data was modified. A combination of a CRC generator and a machine generated password may be used to create a secure and binding environment.

Function Drivers

In computer systems, main memory design has been increasing performance by going to double wide busses and improved device performance but it is still not keeping pace with the CPU and Graphics load demand. Costs for main memory have remained constant or slightly growing over time with unit device count hovering around eight DRAM devices for main stream applications give or take four devices depending on commodity pricing at any given time. The performance gap between the main memory and the traditional HDD also continues to widen.

An end-user add-in memory module that fills the performance gap between main memory and the HDD is provided by various embodiments of the present invention. Various embodiments of the invention meet the desirable goal of not adding cost to the base computer system. Embodiments of the invention are scalable over time, and provide an independent path for the system to access information. FIG. 3 shows the memory hierarchy with an ExpressCard based hybrid memory module. This is a four tier personal computer memory hierarchy illustration. Level 1 is the CPU with associated internal cache. Level 2 is the main memory DRAM. Level 3 and Level 4 is the memory module with the DRAM and FLASH at the associated respective levels and Levels 5 and 6 at the hard disk drive having a FLASH write buffer for the HDD and then the hard drive mechanical media respectively. This provides a function similar to that which the L1-L3 caches provide for the CPU with respect to main memory. The memory module of the invention delivers a low latency path to predetermined programs and data. It supports a user defined priority selection and a dynamic learning ability to manage a user's system for increased performance. FIG. 3 also shows where the memory module is in the PC system memory hierarchy. New system interfaces have been implemented that allow the addition of significant performance in the system. It is noted that this solution provides a backwards compatible path to existing systems that may not have implemented a FLASH write buffer on the hard drive and or have any additional capability designed into the system of a similar nature. This is an external plug-in device similar in nature to Flash Cards commonly used on Camera's and PDA's today. There are other significant values that this technology brings to a PC. Embodiments of the present invention can improve HDD reliability by keeping the HDD turned off for significant amounts of time, which also can reduce overall power consumption on laptops.

System Boot Manager

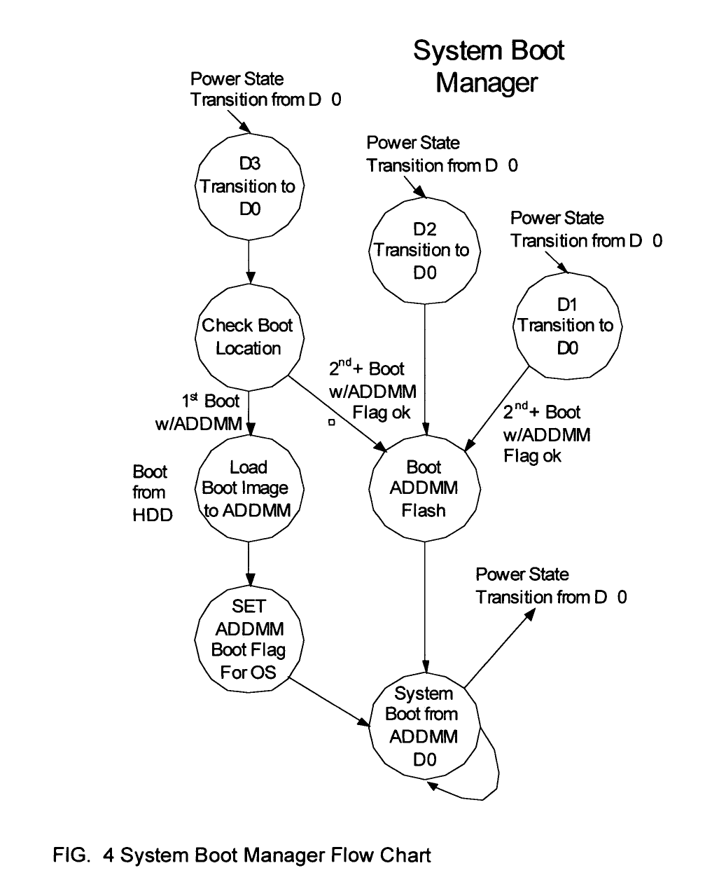

At a first host system power-up, when the memory module in accordance with the present invention is first detected but not yet active, software drivers will boot the system from the HDD as any normal system would. Concurrently with the host system booting, the software driver copies the appropriate boot image to the memory module. The memory module may store the boot image in both the DRAM as well as the FLASH memory space for future usage. Memory module configuration and configuration settings are used to determine whether to store the boot image in FLASH alone, or in both FLASH and DRAM of the memory module. The driver software will then change the boot pointers to the memory module for all subsequent boot operations either from hibernate or from hard power on. Refer to Tables 2 through 5 for power state information and FIG. 4 for the System boot manager flow chart.

Operating System (OS) providers may take advantage of memory modules in accordance with the present invention as it is possible for the system to boot the 1^{st} time from the memory module with preloaded OS launch codes installed. This obviates the need for the system to boot from the HDD and provides a significant improvement in system performance during the initial system boot sequence regardless of initial power state starting point. Other applications and data may also be preloaded on the memory module for ease of installation and rapid launch. Also note that the function of the system boot manager is not to replace the current S3 state manager that is heavily used in today's laptop personal computer systems.

TABLE 2
Global Power States

| | |
|---|---|
| G3 | Mechanical Off |
| G2/S5 | Soft Off |
| G1 | Sleep state |
| G0 | Active state |

TABLE 3
Device Power States

| | |
|---|---|
| D3 | Power Off |
| D2 | Conserve more power preserve less context |
| D1 | Save less power preserve more context |
| D0 | Fully on |

TABLE 4
Sleep States

| | |
|---|---|
| S5 | Soft off, visually off state, OS does not save system context |
| S4 | Hibernate state, long wake latency, context is saved in |
| | non-volatile storage |
| S3 | Sleep state, low wake latency, context is saved in volatile |
| | active memory |
| S2 | Not applicable for PC application and or rarely used |
| S1 | Sleep state, lowest wake latency, all system context is |
| | maintained in all devices. |

TABLE 5
Memory Module Power State Context Map

| | System | | | | |
|---|---|---|---|---|---|
| State | Status | FLASH | Cntrlr | DRAM | Notes |
| G3/D3 | Mech Off | OFF | OFF | OFF | No System Context in Memory |
| | | | | | Module (MM), New boot from MM or |
| | | | | | HDD |
| G3/D3* | Mech Off | OFF | OFF | OFF | System Context in MM FLASH |
| S5/D3 | Soft Off | OFF | OFF | OFF | System Context in MM FLASH |
| S4/D2 | Hibernate | Stand-by | Stand-by | OFF | System Context in MM FLASH |
| S4/D2** | Hibernate | Stand-by | Stand-by | Self- | System Context in MM DRAM |
| | | | | Refresh | |
| S3/D1 | Stand-by | ON | Stand-by | Self- | System Context in Main memory |
| | | | | Refresh | |
| D0 | ON | ON | ON | ON | System Context in DRAM |

*Optional definition for G3/D3 state - System Context is stored in FLASH for a fast boot.
**Optional definition for S4/D2 state - improve system performance w/reduced battery life.

The memory module of the present invention is primarily focused on Power up from S4, S5 and D3 states as well as accelerating other programs not typically saved as part of the S3 state management contained in the DRAM during S3 or normal operation. Such memory modules also reduce dependency on hard disk drives.

System Boot Operations

Referring to FIG. 4, it can be seen that there are several launch points for the boot manager. FIG. 4 shows how a personal computer transitions from various mechanical power states and the possible directions that it can take when a memory module in accordance with the present invention is installed. The function of the memory module from these states is to accelerate the system's response to a change in these states be it from a hard power on reset to a soft start from hibernate. Such memory modules provide the capability for an accelerated soft reset from any operating state so long as a known good boot image is in the memory module.

The primary power transition state is from D3 (mechanical off) to D0 (fully on). This is considered the primary boot state and/or the initial state. After power is detected good, and reset is removed from the system, the memory module controller checks for valid boot pointers and/or flags indicating whether this is a fresh boot or a subsequent boot with a stored boot image available. If this is the 1^{st} boot while the system is booting from the primary non-volatile storage device, which is usually a hard disk drive, this boot image is copied to the memory module for subsequent restarts. Flags and pointers are then set for subsequent system restart events and the system is considered active. If the check boot event sees flags that indicate that this is a 2^{nd} boot and can launch the boot sequence from the memory module, the boot code is sourced from the memory module to the system for booting purposes and a normal but significantly faster restore sequence is completed. Because the memory module is in a different and independent path from that of the primary storage device while the system is booting from the memory module it can begin and service other requests from the primary storage device simultaneously with the restore sequence. Likewise if multiple memory modules are present in a system and if that system desires to retrieve multiple independent threads of information at the same time this is easily accomplished as each memory module is linked via an independent link and thus avoids connection conflicts.

System Boot 2^{nd} and Successive Operations

Once the system has been operating and the appropriate information has been loaded into the memory module, all successive operations will then launch from the memory module either from the DRAM or from FLASH depending on prior usages and information stored by the MRU (Most Recently Used) manager. The 2^{nd} system restore is from the D2 power state which would be the mechanical equivalent to hibernate and/or the S4 state. In order for the state machine to consider a launch from this state, flags would have to have been set to indicate that the system can boot from this memory module. A similar requirement exists when transitioning from a D1 (mechanical standby state) to the D0 full on state. The primary differences of operation, of the memory module in D2 and D1 states, is outlined in Table 5. The main difference is where the restore code is sourced from in each of these power states.

Most Recently Used Manager

The MRU manager is responsible for keeping the program usage information up to date. This is a separate manager that runs independent of other managers.

The MRU list is maintained as a non-volatile image that can be restored to higher performing volatile memory locations as needed. The program data list is shown in Table 6.

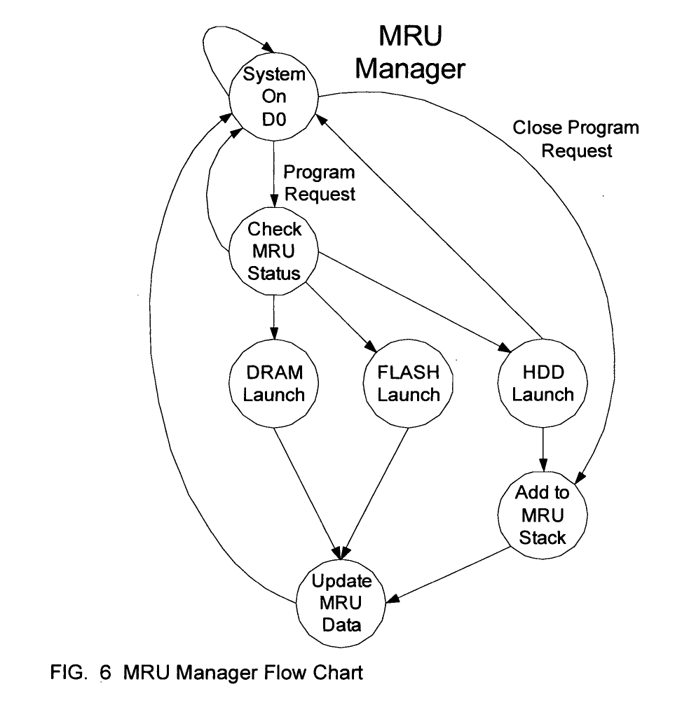

Once a program has been launched and remains open it is maintained in the main memory DRAM unless the host system resources get consumed and then it pages data from the source location, in this case the memory module. FIG. 6 is a simplified flow chart of how the MRU handles the data flow. The system starts from the D0, fully on state. A data set request is issued from the host system and the driver determines if that data set is available in the memory module. If that data set is available, the request is issued to the memory module where it checks the pointers for where to retrieve that data. One of two options exist, i.e., either source from DRAM or source from FLASH. Once the data is sourced from either location the MRU list is updated and the source pointers are moved to the top of the MRU list.

If the data was not available in the memory module and is sourced from the HDD and if the appropriate flags are set indicating that this data set should be managed via the MRU, then that data set is stored in the memory module either in DRAM and or in FLASH depending on flagged preference. Automatically it would be added to DRAM and then eventually moved to flash in the event that DRAM resources were needed for other functions and/or as the priority is moved over time if the data is not accessed.

Part of the maintenance algorithm that can add performance is to purge the memory module DRAM of the image content if a program is maintained as open in the main memory. If the program is closed then the launch image is put back into memory module DRAM for future launch requests. This would free up the scarcer DRAM resources for other applications. This would require the system to move the contents either from main memory or the primary mass storage device to the memory module DRAM space. As long as the data is sourced from a location not in high demand and/or is run as a secondary non-priority event, system performance impacts will be minimal.

TABLE 6
Program Data Table Definition

| Data Type | Bits | Definition |
|---|---|---|
| Priority in MRU Stack | (tbd) | XXXX - Define location in the MRU stack |
| Program image size | (tbd) | XXXX - Program size, used for determining bump |
| | | requirements. |
| Program Launch | 2 | 00 - HDD Launch as default |
| Location Flag | | 01 - Memory Module DRAM |
| | | 10 - Memory Module FLASH |
| | | 11 - Bypass MRU manager, HDD launch only |
| Auto launch override | 1 | 0 - Normal operation |
| | | 1 - refer to Program Launch Location flag |
| Program Opened time | (tbd) | 0000 - |
| stamp¹ | | XXXX - Time stamp when program was opened |
| | | 1111 - |
| Program open time | 3 | 000 - Open then sequentially closed no movement on MRU |
| between program | | stack |
| access¹ | | 001 - time steps to keep program open and or |
| | | available in DRAM or flashy minutes per |
| | | increment |
| | | 110 |
| | | 111 - Opened and never closed |
| Program Idle time¹ | (tbd) | 0000 - |
| | | XXXX - Time steps between last access. |
| | | 1111 - Exceeded available time |
| Data Scratch pad | 1 | 0 - No |
| requested on Memory | | 1 - Yes |
| Module | | |
| Program Size | (tbd) | XXXX - kB/MB or pages required |
| Scratch pad size | (tbd) | XXXX - Block size requested to be held open |
| requested | | kB/MB/Pages/Block sizes |

Notes:
¹Auto launch override negates this function

TABLE 7
MRU Data Table

| Priority | | | Idle | | |
|---|---|---|---|---|---|
| Load | Program | Override | time | D/F | Action |
| 1 | OS Boot Image | Yes | ∅ | F | Fixed in priority |
| | | | | | sequence |
| 2 | Outlook | Yes | ∅ | D/F | Fixed in priority |
| | | | | | sequence |
| 2 | Explorer | Yes | ∅ | D/F | Fixed in priority |
| | | | | | sequence |
| 3 | Net Meeting | NO | 1 min | D/F | |
| 4 | Adobe Acrobat | NO | 10 min | F | |
| 5 | Adobe | NO | 2 min | D/F | Change priority |
| | Elements | | | | location, Idle time |

If the system is started from a power off state and the boot image is kept in the FLASH portion of the memory module then the boot image is read from FLASH. At the same time the ongoing useful elements of the operational image are loaded into the DRAM. The MRU list is then loaded successively from the FLASH to the DRAM to an as of yet predefined allowable fill level as DRAM resources on the memory module are limited and required for other functions. This would allow for the optimal performance from the system for that pre-defined list. A certain amount of DRAM is required to be kept available for write buffering and data read buffering. Again this is done to maintain a very high level of system performance for the program(s) that are executing from memory module that are traditionally targeted for the hard disk drive.

After the system has booted, as the user launches programs (e.g., web browser, email, etc.) a list of most recently used programs is created by the driver. These programs, as they are launched, have their launch image copied to the memory module with future launches redirected to that module.

Launch Acceleration

Once the system has been operating and the appropriate information has been loaded into the memory module all successive operations will then launch from the memory module either from the DRAM or from FLASH depending on prior usages. The drivers need to keep track of the MRU and the LRU (least recently used) programs and data. A set of general operational rules are applied as a 1^{st} level operational state. No intervention is required by a user of the host system.

Unless stated otherwise, when program images are copied to the memory module they are copied to both the DRAM as well as the Flash memory devices.

The memory module may also act as an HDD and use the flash for paging from the DRAM as necessary until it to reaches a full or close to full state.

In order to achieve such functionality, various embodiments of the present invention provide for: 1) boot image and OS operational image being maintained on the memory module; 2) an MRU algorithm employed to keep images at the ready for highly used programs; and 3) the drivers continuously monitor memory module usage and the MRU list.

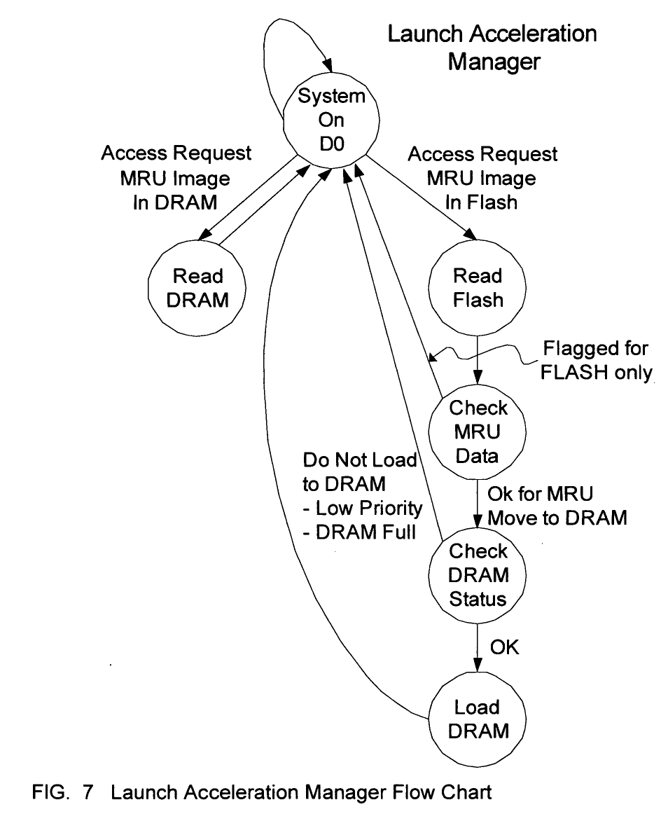

The launch acceleration manager simplified flow diagram is shown in FIG. 7. The main purpose of this engine is to manage the relevant flags and pointers to place data sets in the proper locations. Any requests from DRAM are read from the DRAM and no additional action by the launch accelerator is necessary. If the request is sourced from FLASH, then a series of checks are made and data movement may be initiated to DRAM if the appropriate flags are set and all criteria are met as previously described.

Launch Acceleration User Override Manager

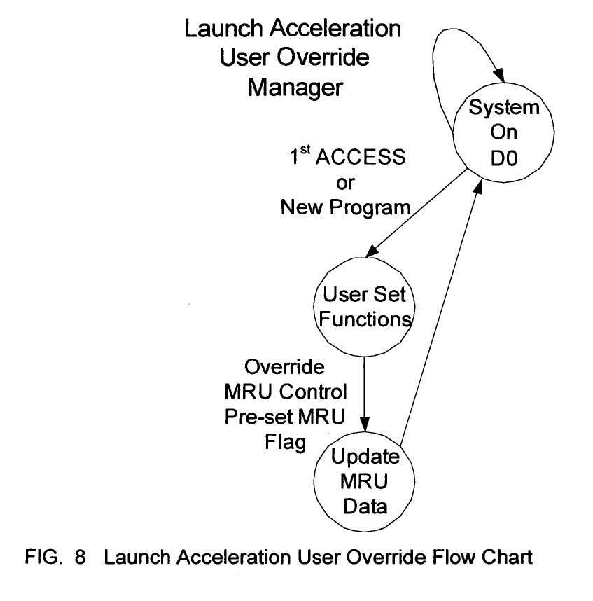

It is desirable to give the user options via a graphical user interface (GUI) to identify key programs and features that they want as part of the accelerated operation that override the MRU algorithm. This feature is intended for use by experienced users that know what they want from the system and how they want it to behave. That is, maintain a predetermined set of programs that need to be instantly available regardless of prior usage mapping, and elements of programs (e.g., cookies or temp files) that may want to be stored in a location other than the system HDD for security or other reasons. FIG. 8 is a state transition diagram of the user override state machine, which is used to manage the MRU data sets for user selected data set pinning. These user selected elements take priority over algorithm based system determinations. In many instances, users may want to dictate what applications and/or data sets are always put in the memory module for acceleration.

If the memory module is equipped with sufficient storage capacity to hold all active and/or recently used programs and associated data, then the primary mass storage (e.g., HDD), of the host system may only be used infrequently and only on an as needed basis to hold a back-up image of the memory module. Once the memory module gains a capacity of 4-8 GBytes there is a high probability that this is enough capacity to store most commonly used applications today, including the OS, and associated data sets. This can allow for lower power, higher performance systems. It will be appreciated that memory requirements may increase over time and that the foregoing memory size is for illustrative purposes and does not limit the present invention.

Adaptive Learning Algorithm

As noted above in connection with Table 7, data is collected and stored on usage of the applications over a period of time. Part of the value added capability of this module is the ability to adapt to users behaviors without user intervention. Tracking not only program type but average duration of use and sequence of usage the system can be tracked real time to provide a user optimized interface.

The following is an example of an illustrative adaptive learning algorithm. In this example a user boots his PC routinely, opens email and reads it, then opens a web browser to surf for news, then opens some other program to do work. The adaptive learning algorithm tracks the sequence of events, the duration of usage of those events and the natural end behavior (i.e. shuts the program off, keeps it running in background). With this information the system can then determine what to do with that particular program and where to maintain the operational image for optimal system performance. When system elements are in a natural idle or low use state, the host system pre-loads programs and data into the memory module's DRAM for accelerated use, and puts less frequently used information into the flash on the memory module. In various embodiments, if the information is rarely used again and space is needed in the memory module, then that information is left on the HDD. By tracking and following this sequence of events the system is generally more ready for the user, and latency to access functions is substantially reduced. Further embodiments of the present invention apply this stored knowledge base to the initial launch and automatically configure the system to a user's needs while running in a background mode such that his/her email, web browsing and other elements are ready for the individual without slowing down the user of the system. That is, existing functional programs have priority, but when the system is in a low use state it prepares for the next level of expected system functionality.

The other natural use of this gathered information is when the user goes to shut down the host system. By having the sequential and time information available to the system during shut down, the host system can reconfigure itself to be ready for the next hard power on. In this way, the host system is constantly adapting to the individual's usage while it is powered on and may be required to give up previously stored information unless flagged as permanent.

Memory Module Maintenance Functions

There are several functional elements that fall into the category of “maintenance”. Since various embodiments of the present invention provide an adaptable system, various forms of maintenance are needed to prevent catastrophic failures and reduction in performance, as well as to be prepared for future operations. Those skilled in the field and having the benefit of this disclosure will recognize that these functions may be managed by hardware, by embedded firmware, by host system drivers, or by combinations of the foregoing. Each maintenance function will identify which mechanisms are available. There are 16 defined maintenance functions.
1. Available DRAM space—The driver manager must keep track of available DRAM space for allocating programs and operations. This data is maintained real time. See program size reference in Table 6 (Module size−installed program−Set aside scratch pad=Available space). There are several algorithms available to automatically test and detect the memory space borders that can be employed to set the value for this field. This function is typically managed in hardware or by embedded firmware.
2. Available Flash space—The driver manager must keep track of available Flash space for allocating programs and operations. This data is maintained real time. See program size reference in Table 6 (Module size−installed program−Set aside scratch pad=Available space). There are several algorithms available to automatically test and detect the memory space borders that can be employed set the value for this field. This function is typically managed in hardware or by embedded firmware.
3. Flash write Leveling—Due to the limitations on Flash write cycles, a leveling algorithm must be employed in order to prevent premature cell degradation. The write allocation algorithm is required to spread writes across the Flash device to prevent any early failures. Several methods are available to manage this, for example: 1) Rotating page pointers; 2) Block counters; 3) random address mapping; and 4) data rotation for opening lesser used blocks. Data from this manager is used in a life meter. The life meter indicates to the user the current state of write life remaining and the expected data retention duration as both of those events can and will lead to device failure. This function is typically managed in hardware or by embedded firmware, although it is possible that this may be managed by external drivers and/or by the operating system. In some embodiments, the volatile memory of the memory module is used to temporarily store data from the FLASH prior to that data being rewritten to a different portion of the FLASH.
4. DRAM Write buffer flushing to Flash—Due to the volatile nature of DRAM, periodic writing of the critical DRAM data to flash for backup is advantageous. This is done based on a timer and/or critical function such as closing a program. This is done to ensure data integrity in case of a power loss and or other volatile event where data may not be maintained. Various embodiments of the memory module include a power failure data save function. In such embodiments the memory module controller writes the critical data from DRAM to flash. This feature may not be included in all embodiments of the memory module in order to lower cost. There is a host system command associated with this manager whereby the operating system and/or drivers can force a DRAM flush to flash. This function is typically managed in hardware or by embedded firmware.
5. Flash flushing to HDD—As a precaution and as a failsafe self back up mechanism a Flash Flush to HDD is included in some embodiments of the present invention. This provides a backup image of the flash device in case of a memory module failure and/or the need to operate the host system without the module attached. Hardware support and driver support is needed for this function. As with all elements in the module, an image is maintained in the HDD in case of device failure. This along with other flush events can be accomplished using spare available cycles. As the flushing events are not critical time driven events they can be squeezed in when opportunities present themselves, similar to how DRAM refresh is managed. This maintenance feature will almost always be managed by an external driver and or by the operating system. There may be custom installations where this function would be managed by embedded firmware.
6. Device Failure manager—As with any technology product, device failure is an inevitable event. To reduce the likelihood of a catastrophic event, a Device Failure Manager is used by various embodiments of the present invention. There are several indicators available to the manager in helping determine the reliability of the operating device e.g., Flash block write counter, ECC/EDC data, power use sensor data, and so on. As blocks fail or memory locations fail, this manager is used to remap the contents to functional memory space. Failures can and will occur in both storage types but would expect to be most prevalent in the FLASH memory type. This manager is typically implemented in embedded firmware with external drivers to manage some system related pointers and activity in the event of major or catastrophic events.
7. DRAM Read/Write buffer updates—since this is an adaptable system the DRAM will require active content management. This means that contents from Flash and from the HDD will be loaded into the DRAM image space. Various factors will indicate which applications and data are held in this space. The DRAM also acts as a write buffer for the system which allows the HDD to be shut off for extended periods of time. This does two things: 1) lowers power consumption; and 2) reduces HDD failures.
8. DRAM refresh management—DRAM requires refresh activities in order to maintain data integrity over a period of time. There are several well known algorithms used to manage this. A common one is where during idle times the DRAM is refreshed which in this case should be enough to maintain the DRAM, however a timer event is also utilized where if the DRAM is reaching a critical refresh state it is forced to refresh at the next available transition. This maintenance function is typically implemented as hardware or part of the embedded firmware.

9. Power loss algoithm—As mentioned in connection with the DRAM flushing to FLASH, the very likely scenario is a power loss event. An option for the module is to have an uninterruptible power supply with energy reserves to Flush the critical DRAM data to the Flash on the memory module.

TABLE 8
UPS Power Calculations

| | | | | Component | VR |
|---|---|---|---|---|---|
| | FLASH | DRAM | Controller | Power | Efficiency |
| | | | | | 85% |
| Voltage (V) | 3.3 | 1.8 | 1.2 | 4.8 | 4.8 |
| Current (mA) | 15 | 120 | 100 | 80 | 94 |
| Power (mW) | 49.5 | 216 | 120 | 385.5 | 454 |

| RAM Capacity | 128 MB | 256 MB | 512 MB | 1024 MB |
|---|---|---|---|---|
| Time (sec) | 13 | 25 | 50 | 100 |
| Battery Life | 0.341 | 0.656 | 1.312 | 2.625 |
| mA-hrs | | | | |

When the memory module controller detects a power loss event, the data that is flagged as critical is flushed to the FLASH, a flag is set and the memory module then shuts down. At new power on the normal power on sequence is followed and data restored to the DRAM.
10. Security management algorithm—Since typical embodiments of the present invention are removable, there is a need for security. Many corporations and/or individuals require password protection. As part of the protection, various memory modules in accordance with the present invention maintain password protection as well as tamper protection. An illustrative algorithm is as follows. If the memory module remains in the original computer then a password is not required for entering and/or exiting. If the memory module is removed and password protection is enabled then a password is required to access the module. This capability may be enabled or not in accordance with a user's preference. After a predetermined number of failed password tries, the contents of the memory module will be erased, if this capability is enabled. This is to limit the ability to get data off of the module in case of theft. Some embodiments may be required to conform to the CPRM (Content Protection for Recordable Media).
11. Coherency with HDD images—Maintaining coherency is vital to the host system. All memory paths are currently coherent with each other. From the Cache on the CPU, through main memory all the way to the hard drive. This new memory module is required to be no different. It is necessary to prevent the wrong data from being read from the various system elements. Coherency is managed by the operating system and/or external drivers, not by the memory module controller. In an alternative embodiment this function could be embedded in the memory module controller.
12. MRU list with time, sequence—The memory module maintains a real time run list of the “Most Recently Used” programs. The data is stored with sequence of access, duration of active use, duration of idle, and usage pattern prior to shutting down that program. This information is used to adapt the loading sequence to each individual user. This function is typically implemented as part of the embedded controller and/or hardware state machine. External management of this by the operating system is expected but will be treated as user controlled data sets.
13. LRU list w/time, sequence—Some applications and/or programs may fall into a category of very limited use. These programs will be flagged with the markers “Least Recently Used” programs. They will also contain all of the information as listed in the MRU description. This is to prevent these types of programs from clogging the memory module and causing unnecessary system delays. This feature can be disabled in accordance with a user's preference. External management of this by the operating system is expected but will be treated as user controlled data sets.
14. Always Used list—There is a category of programs that can be flagged by the user. These programs fall into the category of “Always Used” and are flagged by the user as being wanted available at all times. These are heavily used programs that are considered a ubiquitous part of the user's desktop. Implementation of this function can be made by embedded firmware control, hardware control or by external operating system or drivers.
15. Defrag—There may be some need for optimal system performance to periodically de-fragment the Flash memory. Various embodiments include a built-in feature that automatically limits the fragmentation via a fragmentation list that is maintained real time.
16. Failed bit mapping—As with any computer device there will be bit failures. In order to prevent long term system problems these bit failures are mapped out of the memory usage list. This failed bit mapping also tracks a percentage and time delta of failures. This data will be used by the host system to set a flag indicating that the memory module is at risk of complete failure and should be replaced.
   Conclusion

Embodiments of the present invention find application in PC systems and in entertainment systems where one or more devices may be utilized. Various embodiments of the present invention provide methods and apparatus to improve power utilization, manage data integrity, ensure memory stability over time, and to improve system response time for the end-user through adaptive learning methodologies.

An advantage of some embodiments of the present invention is an improvement in computer system performance and response as it relates to application and data set availability to the end-user during active states, and during power up from various powered down states.

It is understood that the present invention is not limited to the embodiments described within, but encompasses any and all embodiments within the scope of the subjoined claims.

What is claimed is:

1. A removable memory module, comprising:
a volatile memory;
a non-volatile memory; and
a memory module controller, coupled to the volatile memory and the non-volatile memory, that provides address, data, and control interfaces to the volatile memory, the non-volatile memory, and to a host system;
wherein the memory module controller is operable to transfer data from at least one of the volatile memory and the non-volatile memory to a main memory of a host system responsive to the detection of a power state transition in the host system.

2. The removable memory module of claim 1, wherein the memory module controller is further operable to determine whether to store a boot image in the non-volatile memory or in both the volatile and the non-volatile memory.

3. The removable memory module of claim 1, wherein the memory module is preloaded with OS launch codes.

4. The removable memory module of claim 1, wherein the memory module is preloaded with application software and data.

5. The removable memory module of claim 1, wherein the memory module controller is further operable to check for valid boot pointers and/or flags indicating whether a system boot operation is a fresh boot or a subsequent boot with a stored boot image available.

6. The removable memory module of claim 1, wherein the memory module controller is further operable to generate a list of the most recently used applications.

7. The removable memory module of claim 6, wherein the most recently used list is maintained as an image in the non-volatile memory.

8. The removable memory module of claim 1, wherein the memory module controller is further operable to receive a data set request from a host system, and responsive thereto determine whether data set is stored in the volatile memory or the non-volatile memory.

9. The removable memory module of claim 8, wherein the memory module controller is further operable to update a list that is indicative of the most recently used data.

10. The removable memory module of claim 9, wherein updating the list comprises moving the data set source pointer to a top of the list.

11. The removable memory module of claim 1, wherein the memory module controller is further operable move at least a portion of the contents of the volatile memory to a portion of the non-volatile memory when the volatile memory is needed for other data storage operations.

12. The removable memory module of claim 11, wherein the memory module controller is further operable to purge a least a portion of the contents of the volatile memory if those contents are maintained as open in a main memory of a host system to which the removable memory module is coupled.

13. The removable memory module of claim 1, wherein the transferred data is one of an application program or an application program image.

14. The removable memory module of claim 1, wherein the memory module controller is further operable to maintain at least a portion of the volatile memory as a write buffer for writes to the non-volatile memory.

15. The removable memory module of claim 1, wherein the memory module controller is further operable to maintain at least a portion of the volatile memory as a read buffer for reads from the non-volatile memory.

16. The removable memory module of claim 1, wherein the memory module controller is further operable to receive and store launch images of applications as the applications are launched by a host system.

17. The removable memory module of claim 16, wherein the memory module controller is further operable to store the launch images in both the volatile and non-volatile memories.

18. The removable memory module of claim 1, wherein the memory module controller is further operable to track which applications are launched, the duration of use of the launched application, and the sequence of launch of the applications.

19. The removable memory module of claim 1, wherein the memory module controller is further operable to determine an average time of use of launched applications.

20. The removable memory module of claim 1, wherein the memory module controller is further operable to track the amount of available space in the volatile memory, track the amount of available space in the non-volatile memory, and to track the amount of write life remaining in the non-volatile memory.
